(19) United States
(12) Patent Application Publication
(10) Pub. No.: US 2026/0277478 A1
(43) Pub. Date: Sep. 17, 2026

(54) SYSTEMS AND METHODS FOR ADDRESSING MEMORY DIE CONTENTION

(71) Applicant: Samsung Electronics Co., Ltd., Suwon-si (KR)

(72) Inventors: Mark Allen Gaertner, Fort Myers, FL (US); Vipin Kumar Agrawal, San Jose, CA (US); Siamak Arya, Cupertino, CA (US)

(21) Appl. No.: 19/265,234

(22) Filed: Jul. 10, 2025

Related U.S. Application Data
(60) Provisional application No. 63/771,168, filed on Mar. 13, 2025.

(51) Int. Cl. G06F 3/06

(52) U.S. Cl. CPC G06F 3/0659; G06F 3/0613; G06F 3/0679

(57) ABSTRACT

Systems and methods for addressing memory die contention are disclosed. The method may include receiving a first stream including first data; determining availability of a first storage element and a second storage element from a set of storage elements; identifying state information for the first stream, wherein the state information includes a first assignment state of the first stream relative to the first storage element and a second assignment state of the first stream relative to the second storage element; based on determining the availability of the first storage element and the second storage element, and based on identifying the state information for the first stream, assigning the first stream to the second storage element; and performing an operation on the first data by the second storage element.

### CROSS-REFERENCE TO RELATED APPLICATIONS

The present application claims priority to and the benefit of U.S. Provisional Application No. 63/771,168, filed Mar. 13, 2025, entitled “AVOIDING DIE CONTENTION WITH MULTIPLE STREAMS OF DATA,” the entire content of which is incorporated herein by reference.

### FIELD

One or more aspects of embodiments according to the present disclosure relate to non-volatile memory, and more particularly to systems and methods for addressing memory die contention of the non-volatile memory.

### BACKGROUND

Non-volatile memory, such as NAND flash memory, may be used in storage devices such as solid state drives (SSDs). A NAND flash chip may contain one or more memory dies. Die contention may arise when two or more processes attempt to use the same memory die.

The above information disclosed in this Background section is only for enhancement of understanding of the background of the present disclosure, and therefore, it may contain information that does not form prior art.

### SUMMARY

One or more embodiments of the present disclosure are directed to a method that includes: receiving a first stream including first data; determining availability of a first storage element and a second storage element from a set of storage elements; identifying state information for the first stream, wherein the state information includes a first assignment state of the first stream relative to the first storage element and a second assignment state of the first stream relative to the second storage element; based on determining the availability of the first storage element and the second storage element, and based on identifying the state information for the first stream, assigning the first stream to the second storage element; and performing an operation on the first data by the second storage element.

According to some embodiments, the first storage element includes a first memory die and the second storage element includes a second memory die.

According to some embodiments, the first storage element is associated with a first channel of a memory die, and the second storage element is associated with a second channel of the memory die.

According to some embodiments, determining the availability includes determining that the first storage element and the second storage element are available for performing the operation on the first data.

According to some embodiments, the first assignment state identifies processing of second data of the first stream by the first storage element.

According to some embodiments, the second assignment state identifies the second storage element as open to receive an assignment.

According to some embodiments, the state information is based on a number of storage elements in the set of storage elements open to receive an assignment of the first stream.

According to some embodiments, based on the number of storage elements open to receive the assignment of the first stream falling below a threshold value, identifying a third storage element and associating the third storage element to the set of storage elements.

According to some embodiments, based on a number of storage elements in the set of storage elements being closed to receive an assignment of the first stream, identifying a third storage element and associating the third storage element to the set of storage elements.

According to some embodiments, the first storage element and the second storage element are configured to be managed as a single unit for performing garbage collection.

According to some embodiments, the method further includes receiving a second stream; identifying the second storage element for the second stream; determining association of the second storage element to the first stream; and based on determining association of the second storage element to the first stream, identifying a third storage element of the set of storage elements; and assigning the second stream to the third storage element.

According to some embodiments, the determining the availability of the first storage element and the second storage element is for a plurality of streams. At least one of the plurality of streams may be for garbage collection.

One or more embodiments of the present disclosure are also directed to a storage device that includes: a set of storage elements; a processor; and a memory that stores instructions. In some embodiments, when the instructions are executed by the processor, they cause the processor to: receive a first stream including first data; determine availability of a first storage element and a second storage element from the set of storage elements; identify state information for the first stream, wherein the state information includes a first assignment state of the first stream relative to the first storage element and a second assignment state of the first stream relative to the second storage element; based on determining the availability of the first storage element and the second storage element, and based on identifying the state information for the first stream, assign the first stream to the second storage element; and perform an operation on the first data by the second storage element.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts a block diagram of a storage system configured to address memory die contention according to one or more embodiments of the present disclosure;

FIG. 2 depicts a block diagram of a memory die according to one or more embodiments of the present disclosure;

FIG. 3 is a block diagram of a die array experiencing die contention according to one or more embodiments of the present disclosure;

FIG. 4 depicts a block diagram of the die management device according to one or more embodiments of the present disclosure;

FIG. 5 depicts a block diagram of a die array and a search window covering a subset of the dies in the die array according to one or more embodiments of the present disclosure;

FIG. 6 depicts a flow diagram of a process 600 for addressing memory die contention according to one or more embodiments of the present disclosure;

FIG. 7 depicts a flow diagram of a process for scheduling a stream to a storage element according to one or more embodiments of the present disclosure; and

FIG. 8 is a block diagram for managing ways of a search window according to one or more embodiments of the present disclosure.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

Embodiments of the present disclosure are described below with reference to block diagrams and flow diagrams. Thus, it should be understood that each block of the block diagrams and flow diagrams may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flow diagrams. Accordingly, the block diagrams and flow diagrams support various combinations of embodiments for performing the specified instructions, operations, or steps.

In addition, a feature of embodiments of the present disclosure may be combined or combined with one or more other features, partially or entirely, and may be operated in various ways, and an embodiment may be implemented independently of one or more other embodiments, or in conjunction with the one or more other embodiments.

A storage device may contain non-volatile memory, such as one-or more NAND flash memory chips, for storing data. A memory chip may contain one or more memory dies. A memory die may contain one or more planes. A plane may be divided into blocks of memory, and a block of memory may be divided into memory pages. Multiple physical blocks that may span different planes and/or memory dies may be grouped together to form a logical structure referred to as a superblock.

An input-output (I/O) process (e.g., a stream) may write data to a superblock to which it is assigned. In general terms, programming the memory blocks of the superblock (e.g., writing data to the superblock) may occur in a systematic (e.g., ascending) manner. For example, all of the first addressable dies (e.g., die 0) on all channels may be programmed first in ascending order of channels prior to accessing the subsequent dies (e.g., die 1, die 2, etc.) on their respective channels in ascending order.

Multiple I/O processes attempting to program a superblock according to the systematic pattern, and without other coordination, may result in die contention where two or more streams may compete for the same physical memory position of the superblock. In this case, one of the competing streams may program the memory position while the other competing streams may stall until the memory position becomes available, resulting in performance loss.

It may be possible to mitigate performance loss due to die contention with write buffering. In this regard, a write process that contends for the same die (e.g., same die-channel pair) may buffer the program data in a buffer to continue operation. One issue with this approach may be that large amount of write buffering may be needed when there are many write processes contending for the same die, which may result in degraded performance of the storage device. Adding additional buffers to store large amounts of data may also be cost and/or space prohibitive.

In general terms, embodiments of the present disclosure are directed to scheduling die operations for reducing die contention or write buffering in a superblock. In some embodiments, a die management device tracks availability of one or more dies (e.g., on a global level to determine if any stream is currently using the die) to perform an operation (e.g., a write operation), and selects one of the available dies or die-channel pairs (used interchangeably herein) to assign to a stream based on state information of the stream. The state information of the stream that may be considered in making the die assignment may include the available or open ways (or open die set) for the stream, the dies already active in performing an operation in the open ways, the dies that have already completed operation in the open ways, and the dies with queued operations in the open ways. In some embodiments, a way is a set of dies at the same addressable location on all channels. For example, a way may be all die number N on all channels.

In some embodiments, the die management device may select a die in the open ways that is not already active or has not already completed an operation, and that does not already have a queued operation. In this regard, the selected die may be deemed to be locally open to receive the assignment of the stream. This may allow a more distributed use of the die positions and provide enhanced performance of the memory device.

In some embodiments, die scheduling freedom for a stream (e.g., the number of available die positions to select from) may be depicted as a set of ways. A way may be associated with a die, and may include the one or more communication channels of the die. The number of ways to be considered by the die management device for assignment of a stream may depend on a size of a search window. For example, the search window may include 2 ways (e.g., two dies on channels), 4 ways (e.g., four dies on channels), or the like, where the channels included in the ways include all or a subset of the device channels.

In some embodiments, additional open ways may be added to the search window based on workload (e.g., write workload) associated with the stream. In some embodiments, when a set of storage elements laid across a way are closed for a stream, more storage elements across additional ways may be added to the window by moving the search window to include the open ways, and allowing the closed ways to fall outside of the window. In some embodiments, a way may be closed for a stream when the stream has finished operations to the way. A stream may have finished operations to the way if the stream has completed, issued, and/or queued write operations to all dies of the way.

In some embodiments, the number of open ways in the search window is fixed, and no additional open ways are added to the search window until all ways are closed. In some embodiments, the ways are managed in sets. A new set of ways may be opened when a set of ways is closed. In some embodiments, multiple sets of ways may be open at the same time.

In some embodiments, an operation by a stream is buffered in a write buffer if no available die is identified for assigning to the stream.

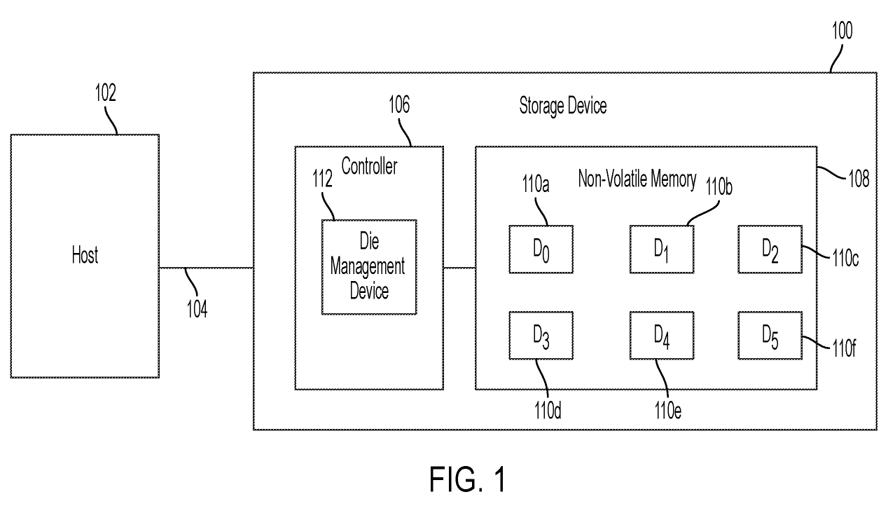

FIG. 1 depicts a block diagram of a storage system configured to address memory die contention according to one or more embodiments of the present disclosure. The storage system may include a storage device 100 coupled to a host computing device (referred to as a “host”) 102 over a communication interface 104. The host may write and read data to and from the storage device 100 over the communication interface 104. The communication interface 104 (e.g., the connector and the protocol thereof) may include (or may conform to) a Compute Express Link^{TM} (CXL^{TM}), Cache Coherent Interconnect for Accelerators (CCIX), Small Computer System Interface (SCSI), Non Volatile Memory Express (NVMe), Peripheral Component Interconnect Express (PCIe), remote direct memory access (RDMA) over Ethernet, Serial Advanced Technology Attachment (SATA), Fiber Channel, Serial Attached SCSI (SAS), NVMe over Fabric (NVMe-oF), iWARP protocol, InfiniBand protocol, 5G wireless protocol, Wi-Fi protocol, Bluetooth protocol, and/or the like. In other embodiments, the communication interface 104 (e.g., the connector and the protocol thereof) may include (or may conform to) various general-purpose interfaces, for example, such as Ethernet, Universal Serial Bus (USB), and/or the like.

The host 102 may include a processor and memory. The processor may be a processing circuit, for example, such as a general purpose processor or a central processing unit (CPU) core of the host 102. The processor may include one or more applications that write and read data to the storage device 100.

The storage device 100 may be considered as secondary memory that may persistently store data accessible by the host 102. In some embodiments, the storage device 100 may be secondary memory of the host 102, for example, such as a Solid-State Drive (SSD). However, the present disclosure is not limited thereto, and in other embodiments, the storage device 100 may include (or may be) any suitable storage device, for example, such as a non-volatile dual in-line memory module (NVDMIMM), universal flash storage (UFS), a secure digital (SD) device, and/or the like. For convenience, the storage device 100 may be described hereinafter in the context of an SSD, but the present disclosure is not limited thereto.

In some embodiments, the storage device 100 includes a storage controller 106 and non-volatile memory (NVM) 108. The NVM 108 may include one or more flash memory devices. A flash memory device may include one or more memory dies 110a-110f (collectively referenced as 110) forming an array of dies and configured to retain data without power. The memory dies may include, for example, NAND flash dies although embodiments are not limited thereto. For example, the memory dies may include magnetic random access memory (MRAM), phase change memory (PCM), ferro-electric Ram (FeRAM), resistive RAM) (ReRAM), and the like.

In some embodiments, the dies 110 may be arranged in one or more memory communication channels connected to the storage controller 106. In some embodiments, the storage controller 106 may include, for example, a digital circuit (e.g., a microcontroller, a microprocessor, a digital signal processor, or a logic device (e.g., a field programmable gate array (FPGA), an application-specific integrated circuit (ASIC), and/or the like (collectively referenced as a processor)). The storage controller 106 may include a memory storing instructions (e.g., software, firmware, and/or hardware code) for being executed by the processor, for carrying out the functionality descried herein.

In some embodiments, the storage controller 106 is configured to receive data access requests from the host 102. The data access requests may include, for example, read/load or write/store requests. In some embodiments, the storage controller 106 receives write data from a host, and aggregates the data into a program buffer (not shown). The data in the program buffer may be associated with a stream. The stream may be an NVMe stream, Flexible Data Placement Mode (FDP) stream (e.g., a reclaim unit handle (RUH)), and/or the like. Programming of the NVM 108 may be initiated when the aggregated data equals or exceeds the size of the program buffer.

The storage controller 106 may be configured to manage various features of the NVM 108 including, for example, input/output (I/O) handling, reading, writing/programming, erasing, garbage collection, wear leveling, address translation, and/or the like.

In some embodiments, the storage controller 106 includes one or more die management devices 112. A particular die management device may manage a subset of the storage elements and further manage one or more streams.

The die management device 112 may be configured to detect a stream (e.g., in the program buffer) and search for an available storage element to assign to the stream. In some embodiments, a storage element may include a die. In some embodiments, a storage element may include a finer level of granularity such as, for example, a plane, block, word line, page, and/or the like. The term storage element and die may be used interchangeably herein. In some embodiments, a pool or set of storage elements associated with a superblock may be candidates for assignment to the stream. In some embodiments, the storage elements may be depicted as a set of ways. A way may be composed of dies on the communication channels. A subset of the ways may be included in a search window, and searching of the storage elements for assignment to a stream may be confined to the storage elements in the search window.

The die management device 112 may be configured to identify an available storage element in the search window. The storage element may be deemed to be globally available if the storage element is not already performing an operation and does not have a queued operation pending. The operation may be, for example, stream or garbage collection operations that may include program operations Hereinafter, the term stream may be used to encompass garbage collection operations. In some embodiments, global availability of a die may be equally applicable to the streams regardless of the stream.

In some embodiments, whether a globally available die may be assigned to a stream may depend on the state of the stream. The state information may determine local availability of the die that is specific to the particular stream. In some embodiments, a globally available die that has already completed an operation for the stream or which has an operation for the stream active or pending, may be deemed to be locally unavailable to be assigned to the stream.

In some embodiments, the die management device 112 is configured to add additional ways to the search window when a threshold number of ways in the search window are closed. The closed ways may be removed (or otherwise disassociated) from the window (e.g., by moving or sliding the window to the next set of ways in the die array), and additional open ways may be added to the sliding window. This may allow maximization of the utilization of the different storage elements of the NVM 108.

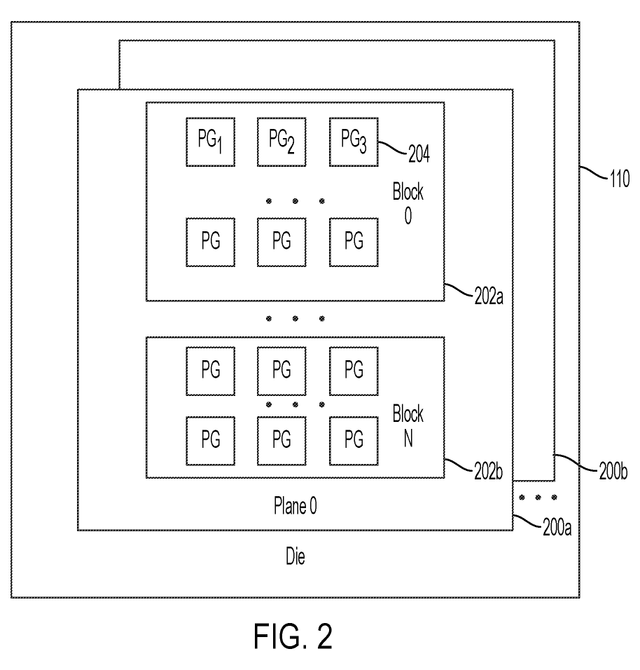

FIG. 2 depicts a block diagram of a memory die 110 according to one or more embodiments of the present disclosure. The die 110 may include one or more planes 200a-200b (collectively referenced as 200). A plane 200 may be divided into one or more blocks of memory 202a-202b (collectively referenced as 202), and a block of memory 202 may be divided into memory pages 204. Multiple physical blocks 202 that may span different planes 300 and/or memory dies 110 may be grouped together into a superblock.

In some embodiments, a stream is assigned to a superblock for writing to the storage elements (e.g., word-lines, blocks, dies, etc.) in the assigned superblock. In this regard, a stream that is assigned to the superblock may not write to storage elements in another superblock. In this regard, a stream may only write to its assigned superblock. However, other streams may have superblocks that are composed of the same dies and planes but not the same erasure block (202) or pages (204)

In some embodiments, the storage elements that are considered for assigning to a stream are searched according to a fixed or systematic searching algorithm or pattern. For example, the searching algorithm may search for the storage elements in ascending order of the memory die addresses (e.g., die 0 channel 0, channel 1, etc.; die 1, channel 0, channel 1, etc.), and attempt to assign the storage elements in the ascending order to the stream. Of course, other patterns may be use for searching for the storage elements, such as, for example, searching in descending order of the memory die addresses. Die contention may occur when competing streams attempt to write to the same storage element.

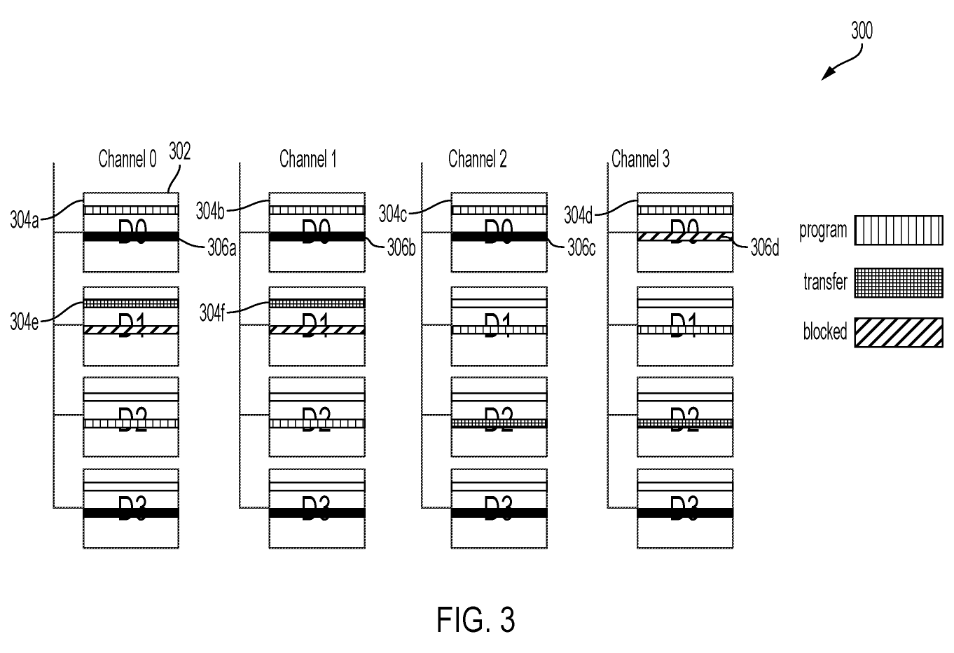

FIG. 3 is a block diagram of a die array 300 experiencing die contention according to one or more embodiments of the present disclosure. The die array 300 may include one or more memory dies 302 D0-D15. The memory dies D0-D15 may form a superblock. In some embodiments, the memory dies are arranged in one or more communication channels (CH) CH0-CH3.

In the example of FIG. 3, an ascending search pattern is used to assign storage elements to streams. In this regard, the dies in the die array 300 may be arranged in ascending order of communication channels, and in ascending order of memory addresses associated with the dies. For example, D0 may have a lower memory address than D1, and may be searched first before searching D1. In some embodiments, a die way may include the various channels of the die. For example, D0, CH0-CH3 of the die array 300 may form a first way, and D1, CH0-CH3 of the die array 300 may form a second way.

In the example of FIG. 3, based on the ascending search pattern used for die scheduling, a first stream is assigned to D0, CH0 for programming first data 304a. The first stream is assigned to D0, CH1 for programming second data 304b, D0, CH2 for programming third data 304c, and further assigned to D0, CH3 for programming fourth data 304d. The programming across the channels of the die may improve sequential read performance.

According to the ascending search pattern, the first stream may further access the next storage elements, D1, CH0 and D1, CH1 for transferring fourth data 304e and fifth data 304f respectively for programming the transferred data to the NAND.

In the example of FIG. 3, a second stream 306a-306c is depicted as having completed use of D0, CH0; D0, CH1; and D0, CH2. The next storage element for use by the second stream according to the ascending search pattern is D0, CH3. However, because the first stream is assigned to D0 CH3 for programming the third data 304d of the first stream, the second stream is blocked 306d from accessing D0, CH3. A die contention therefore occurs between the first stream and the second stream. The second stream is similarly blocked from accessing D1, CH0 and D1, CH1.

In some embodiments, instead of stalling the second stream or buffering data of the second stream to write buffers associated with the blocked storage positions D0, CH3; D1, CH0; and D1, CH1, the die management device 112 searches in ascending order for a next available die in the sequence that was not already used by the second stream, and which is not currently busy handling an operation and does not have a write operation queued to it (e.g., D1, CH2; D1, CH3, and D2, CH0), and assigns the operation of the second stream to the identified storage element. In this manner, the second stream need not stall waiting for the first stream to finish its operation, and write buffering may be minimized, enhancing write performance of the NVM 108.

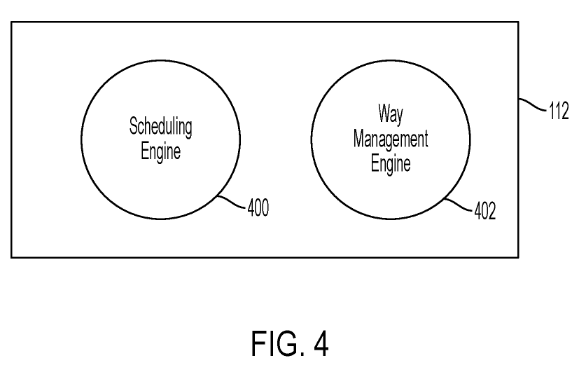

FIG. 4 depicts a block diagram of the die management device 112 according to one or more embodiments of the present disclosure. The die management device 112 may include a scheduling engine 400 and a way management engine 402. The engines 400-402 may be implemented via hardware, firmware (e.g., via an ASIC) and/or by a more general purpose hardware, such as a processor configured to execute instructions stored in a non-transitory storage medium. Although the one or more engines 400-402 are assumed to be separate functional units, a person of skill in the art will recognize that the functionality of the engines may be combined or integrated into a single engine, or further subdivided into further sub-engines without departing from the spirit and scope of the inventive concept.

In some embodiments, the scheduling engine 200 is configured to search for the storage elements in a superblock according to the search pattern or algorithm used by the superblock, and identify a die that is globally available for assignment. A die may be globally available for assignment if the die is not busy with an operation, and does not have a queued operation pending for processing. In some embodiments, the search by the scheduling engine 200 is confined to the storage elements in a search window.

In some embodiments, the scheduling engine 200 examines the state of a stream to be assigned to a storage element for determining which of the globally available storage elements are appropriate for assignment to the stream. The state information may include an assignment state of the stream relative to the available storage elements. In this regard, the globally available storage element that satisfies a criterion for assignment based on the state information of the stream is deemed to be open to the assignment and selected for being scheduled to the stream. The state information may include ways available to the stream for scheduling, the storage elements to which the stream has already been assigned for programming or is currently handling programming, storage elements with queued operations in the available ways, and/or the like. In some embodiments, the scheduling engine 400 may determine that the criterion for assignment is satisfied by a storage element if the storage element was not previously assigned to the stream and there are no other operations queued for the storage element.

In some embodiments, the scheduling engine 200 includes a status buffer for storing a bit map of the storage elements. The bit map may be updated to indicate a storage element as being busy based on a stream being assigned to the storage element. In some embodiments, the scheduling engine 200 maintains a state buffer for the stream for storing the stream state information. For example, the state buffer may include a bit map of the available storage elements (e.g., contained in a search window) for the stream, and identify the storage elements that are unavailable due to the storage element having completed an operation for the stream, due to being currently active in processing the stream, or due to having queued operations for the stream.

In some embodiments, the way management engine 402 is configured to manage the available ways for a stream. In some embodiments, the way management engine 402 dynamically allocates open ways to the stream based on an attribute of the stream. An open way may include one or more storage elements of the way that are indicated as being available to the storage element. The attribute may include, for example, the workload of the stream. For example, a stream may be allocated an initial number of open ways, and additional open ways may be added to the stream by the way management engine 402 based on detected an increase in the write workload of the stream.

In some embodiments, open ways are added for the stream based on detecting a criterion. The criterion may be local availability of storage elements across a way. A way may be closed due to a last storage element in the way being locally unavailable (e.g., due to a last completed program in the way). One or more open ways may be added based on detecting that a way is closed.

In some embodiments, one or more ways may be added based on detecting that a threshold number of available storage elements are locally unavailable. The threshold number may be all the storage elements in the search window, or a portion of the storage elements in the search window.

In some embodiments, one or more ways may be added based on detecting that there are open ways that are remaining to be added to the search window.

The granularity for adding additional open ways may be configurable. For example, a single way may be added at a time by sliding the search window to cover a new way. In other examples, the granularity may be a super word-line. In this regard, a first super word line may encompass a lowest addressable word line in all blocks of the superblock. A word line may be composed of one or more pages

When there are no other positions in the first super word line, a next super word line that encompasses a next physical addressable page in the block may be added to the search window.

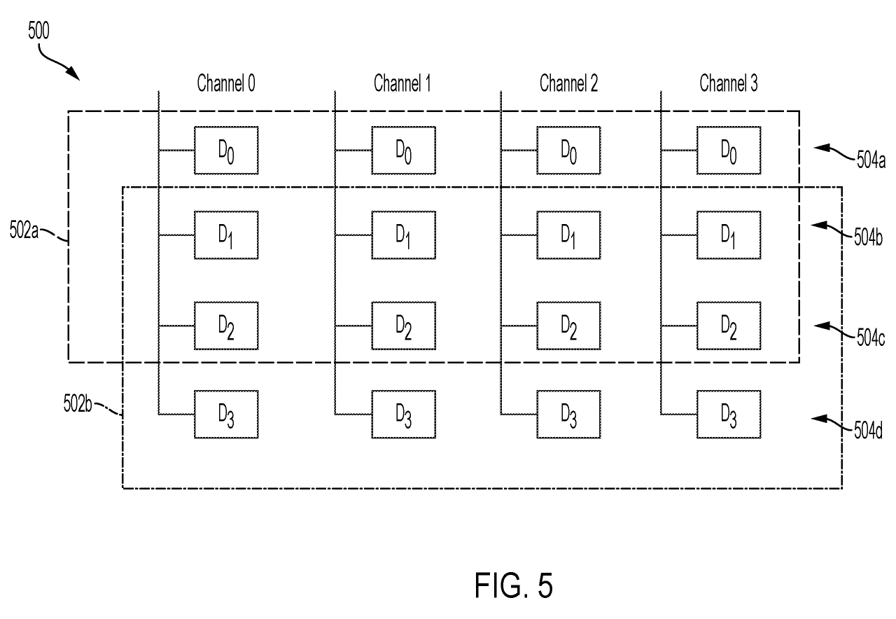

FIG. 5 depicts a block diagram of a die array 500 and a search window 502a, 502b covering a subset of the dies in the die array according to one or more embodiments of the present disclosure. The die array 500 may be associated with a superblock.

In the example of FIG. 5, the search window 502a, 502b includes 3 ways: a first way 504a including the channels for D0; a second way 504b including the channels for D1; and a third way 504c including the channels for D2.

In some embodiments, the scheduling engine 400 restricts the search of available storage elements for assigning to the stream, to the storage elements in the search window 502a. As assignments of the storage elements are made, the state information of the storage element is updated to reflect the assignment.

In some embodiments, the way management engine 402 monitors the state of the storage elements for detecting a condition for adding additional open ways. For example, the way management engine 402 may detect the closing of the first way 504a as a condition for adding an additional open way. The closing of the first way 504a may be detected based on detecting that a last storage element (D0, CH3) in the first way 504a has been scheduled for or has completed an operation of the stream. Based on detecting the closing of the first way 504a, the way management engine may slide the current search window 502a down the die array 500 to add an additional open way 504d. The search window 502b may thus include the additional open way 504d and exclude the closed way 504a. Further assignments of storage elements may be restricted to the storage elements in the search window 502b with the additional open way. The addition of the open way may help increase die scheduling freedom that may reduce write buffering due to unavailability of storage elements, and help promote utilization of different storage elements of the superblock.

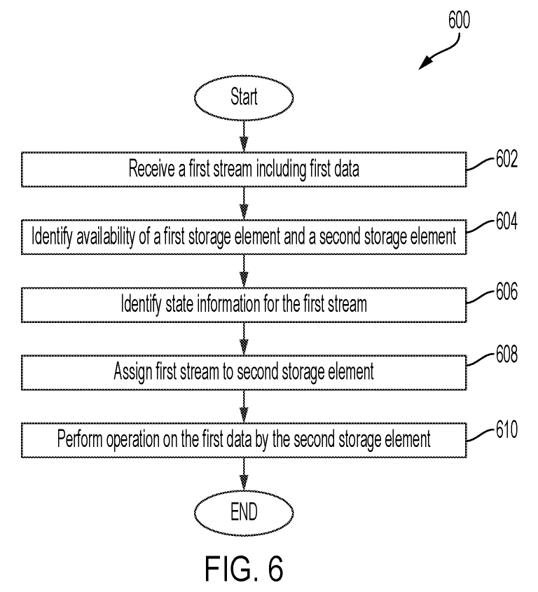

FIG. 6 depicts a flow diagram of a process 600 for addressing memory die contention according to one or more embodiments of the present disclosure. The process starts, and in act 602, the scheduling engine 400 receives a first stream including first data. The first stream may be for performing an operation on the NVM 108. The operation may be, for example, a program operation for programming a memory die 110 for streams (including garbage collection), erase and/or read operations for garbage collection, and/or the like.

In act 604, the scheduling engine 400 identifies availability (e.g., global availability) of a first storage element and a second storage element from a set of storage elements (e.g., available ways for the first stream). In some embodiments, the scheduling engine 400 searches the set of storage elements according to a set search pattern (e.g., based on an ascending memory address of the storage elements). In this regard, the first storage element may have a lower memory address than the second storage element.

The first storage element may include a first memory die and the second storage element may include a second memory die. In some embodiments, the first storage element may be associated with a first channel of a memory die, and the second storage element may be associated a second channel of the memory die. In some embodiments, the first storage element and the second storage element are configured to be managed as a single unit for performing garbage collection. In this regard, the first storage element and the second storage element belong to a superblock to which the first stream is assigned. In some embodiments, determining the availability of the storage elements includes determining that the first storage element and the second storage element are available (e.g., not busy) for performing the operation on the first data.

In act 606, the scheduling engine 400 identifies state information for the first stream. In some embodiments, the state information is based on a number of storage elements in the set of storage elements (e.g., ways) open to receive an assignment of the first stream.

The state information may include a first assignment state of the first stream relative to the first storage element, and a second assignment state of the first stream relative to the second storage element. In some embodiments, the first assignment state identifies the first storage element as being locally closed or unavailable to receive an assignment of the first stream (e.g., due to prior processing or completion of second data of the first stream by the first storage element), and the second assignment state identifies the second storage element as being locally open to receive the assignment of the first stream.

In act 608, the scheduling engine 400 assigns or schedules the first stream to the second storage element.

In act 610, the assigned storage element performs the operation on the first data. The operation may be, for example, programming the first data, and optionally, an erase and/or read operation for garbage collection.

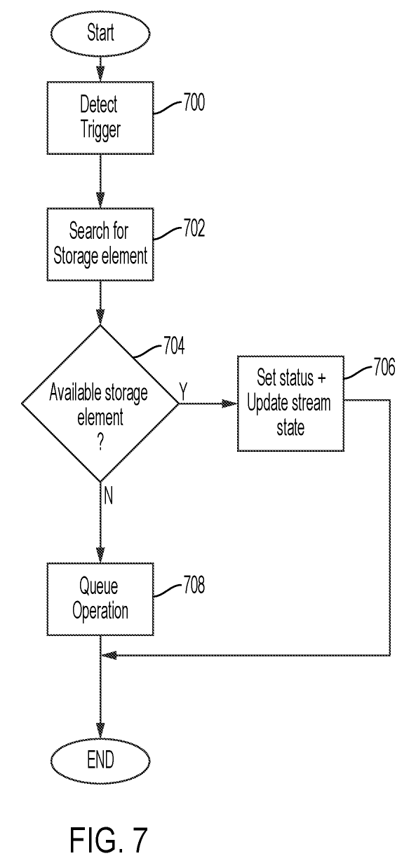

FIG. 7 depicts a flow diagram of a process for scheduling a stream to a storage element according to one or more embodiments of the present disclosure. The process starts, and in act 700, the scheduling engine 400 detects a trigger for initiating the scheduling process. In this regard, the scheduling engine 400 monitors a program buffer onto which write data from the host is deposited. The scheduling process may start upon detecting that the program buffer is full. In some embodiments, the scheduling engine 400 monitors for a specific signal, and starts the scheduling process based on detecting the signal.

In act 702, the scheduling engine 400 searches for available storage elements in the superblock assigned to the stream. In this regard, the scheduling engine 400 searches for the available storage elements by following a preset search pattern or algorithm associated with the superblock. In some embodiments, the search is confined to the storage elements in a current search window. The search window may encompass one or more die ways.

The search algorithm may cause the scheduling engine 400 to search for available storage elements by starting with a lowest addressable storage element in the search window, and determining whether the storage element is globally available. A storage element may be deemed to be globally available if it is not busy performing an operation (e.g., program operation, erase operation, read operation, etc.) and there are no other queued operations for the storage element in a write buffer. In this regard, unlike a scheduling process that assigns the stream to a storage element according to the fixed search pattern even if the storage element is busy with a contending stream (e.g., by buffering the write data), embodiments of the present disclosure allow the scheduling engine 400 to bypass the unavailable or busy storage element to locate an available storage element according to the search pattern.

If a globally available storage elements is found, the scheduling engine 400 determines whether the storage element may be assigned to the stream based on state information of the stream. In this regard, a globally available storage elements may not be locally available or open to assignment to the stream based on the stream state information. In some embodiments, the storage element is deemed unavailable or closed to the stream if the storage element has completed or is currently performing an operation for the stream, or has a queued operation for the stream. Such a storage element may be bypassed by the scheduling engine 400. In some embodiments, a storage element that has not completed an operation or is not currently performing an operation for the stream, or has no queued operation for the stream is deemed locally available to the stream and may be assigned to the stream.

In act 704, a determination is made as to whether a globally and locally available stream is found. If the answer is YES, the global status of the selected storage element is set to indicate that it is busy or unavailable (e.g., by setting the bit map for the storage element in the status buffer). The scheduling engine 400 may further update the state information for the stream (e.g., in the state buffer) by marking the storage element as active or assigned to the stream.

Referring again to act 704, if no available storage element is found, the operation may be queued, in act 708, to a storage element selected as a function of an address (e.g., lowest addressable position), the storage element with the lowest number of pending operations, the storage element with the least amount of time remaining of active and pending operations, or a combination of these factors.

In some embodiments, the state information for the stream is updated to mark the storage element as pending with a queued operation. The state information may be updated to active when the storage element becomes available and processes the queued operation. In some embodiments the write buffer may be a global buffer to which operations for various storage elements may be pending.

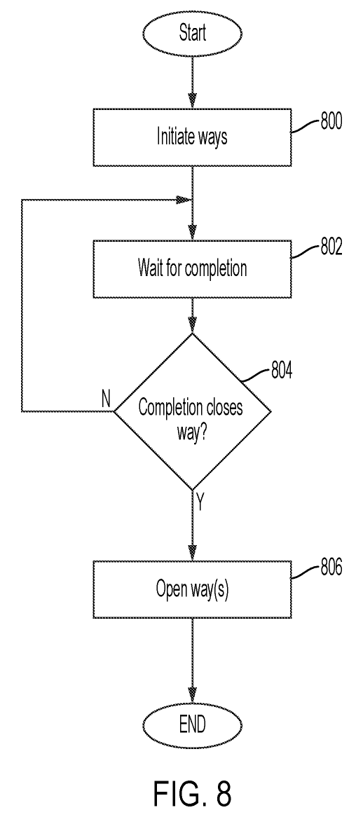

FIG. 8 is a block diagram for managing ways of a search window according to one or more embodiments of the present disclosure. Although the process is described with reference to ways, a person of skill in the art should recognize that the process may apply to any other set or grouping of storage elements.

The process starts, and in act 800, the way management engine 402 proceeds to initiate ways for the stream. In this regard, the way management engine 402 may generate a search window of a set size, and associate open ways based on the set size. An open way may contain at least one available storage position associated with the way.

In act 802 the way management engine 402 monitors for completion of operations by the storage elements.

In act 804, a determination is made as to whether a completion by a storage element closes one or more ways. A way may be deemed closed when there are no available storage positions associated with the way.

If the answer is YES, the way management engine 402 opens one or more additional ways in act 806. In this regard, the way management engine 402 updates the search window to include one or more additional ways with available storage elements not currently included in the search window, and remove from the window the closed way(s). The adding or additional ways may help minimize write buffering that may occur when no available dies are found in the search window.

As a person of skill in the art should recognize, embodiments of the present disclosure help reduce die contention due to multiple streams attempting to write to the same storage element. Write performance of the storage device may thus be enhanced. In addition, by considering the use of the storage elements on a stream-by-stream basis to make or alter the scheduling decision, utilization of the storage device may enhanced. The ability to open additional ways for assignment to a stream may further increase die scheduling freedom which may further enhance die utilization.

One or more embodiments of the present disclosure may be implemented in one or more processors. The term processor may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for addressing memory die contention have been specifically described and illustrated herein, many modifications and variations will be apparent to those skilled in the art. Accordingly, it is to be understood that systems and methods for addressing memory die contention constructed according to principles of this disclosure may be embodied other than as specifically described herein. The disclosure is also defined in the following claims, and equivalents thereof.

The systems and methods for addressing memory die contention may contain one or more combination of features set forth in the below statements.

Statement 1: A method comprising: receiving a first stream including first data; determining availability of a first storage element and a second storage element from a set of storage elements; identifying state information for the first stream, wherein the state information includes a first assignment state of the first stream relative to the first storage element and a second assignment state of the first stream relative to the second storage element; based on determining the availability of the first storage element and the second storage element, and based on identifying the state information for the first stream, assigning the first stream to the second storage element; and performing an operation on the first data by the second storage element.

Statement 2. The method of Statement 1, wherein the first storage element includes a first memory die and the second storage element includes a second memory die.

Statement 3. The method of Statement 1, wherein the first storage element is associated with a first channel of a memory die, and the second storage element is associated with a second channel of the memory die.

Statement 4. The method of Statement 1, wherein determining the availability includes determining that the first storage element and the second storage element are available for performing the operation on the first data.

Statement 5. The method of Statement 1, wherein the first assignment state identifies processing of second data of the first stream by the first storage element.

Statement 6. The method of Statement 1, wherein the second assignment state identifies the second storage element as open to receive an assignment.

Statement 7. The method of Statement 1, wherein the state information is based on a number of storage elements in the set of storage elements open to receive an assignment of the first stream.

Statement 8. The method of Statement 7, wherein based on the number of storage elements open to receive the assignment of the first stream falling below a threshold value, identifying a third storage element and associating the third storage element to the set of storage elements.

Statement 9. The method of Statement 1, wherein based on a number of storage elements in the set of storage elements being closed to receive an assignment of the first stream, identifying a third storage element and associating the third storage element to the set of storage elements.

Statement 10. The method of Statement 1, wherein the first storage element and the second storage element are configured to be managed as a single unit for performing garbage collection.

Statement 11. The method of Statement 1 further comprising: receiving a second stream; identifying the second storage element for the second stream; determining association of the second storage element to the first stream; based on determining the association of the second storage element to the first stream, identifying a third storage element of the set of storage elements; and assigning the second stream to the third storage element.

Statement 12. The method of Statement 1, wherein the determining the availability of the first storage element and the second storage element is for a plurality of streams.

Statement 13. The method of Statement 12, wherein at least one of the plurality of streams is for garbage collection.

Statement 14. A storage device comprising: a set of storage elements; a processor; and a memory storing instructions which, when executed by the processor, cause the processor to: receive a first stream including first data; determine availability of a first storage element and a second storage element from the set of storage elements; identify state information for the first stream, wherein the state information includes a first assignment state of the first stream relative to the first storage element and a second assignment state of the first stream relative to the second storage element; based on determining the availability of the first storage element and the second storage element, and based on identifying the state information for the first stream, assign the first stream to the second storage element; and perform an operation on the first data by the second storage element.

Statement 15. The storage device of Statement 14, wherein the instructions that cause the processor to determine the availability include instructions that cause the processor to determine that the first storage element and the second storage element are available for performing the operation on the first data.

Statement 16. The storage device of Statement 14, wherein the first assignment state identifies processing of second data of the first stream by the first storage element, and the second assignment state identifies the second storage element as open to receive an assignment.

Statement 17. The storage device of Statement 14, wherein the state information is based on a number of storage elements in the set of storage elements open to receive an assignment of the first stream. wherein the based on the number of storage elements open to receive the assignment of the first stream falling below a threshold value, the instructions cause the processor to identify a third storage element and associate the third storage element to the set of storage elements.

Statement 18. The storage device of Statement 14, wherein the based on a number of storage elements in the set of storage elements being closed to receive an assignment of the first stream, the instructions cause the processor to identify a third storage element and associate the third storage element to the set of storage elements.

Statement 19. The storage device of Statement 14, wherein the first storage element and the second storage element are configured to be managed as a single unit for performing garbage collection.

Statement 20. The storage device of Statement 14, wherein the instructions further cause the processor to: receive a second stream; identify the second storage element for the second stream; determine association of the second storage element to the first stream; and based on determining the association of the second storage element to the first stream, identify a third storage element of the set of storage elements; and assign the second stream to the third storage element.

What is claimed is:

1. A method comprising:
receiving a first stream including first data;
determining availability of a first storage element and a second storage element from a set of storage elements;
identifying state information for the first stream, wherein the state information includes a first assignment state of the first stream relative to the first storage element and a second assignment state of the first stream relative to the second storage element;
based on determining the availability of the first storage element and the second storage element, and based on identifying the state information for the first stream, assigning the first stream to the second storage element; and
performing an operation on the first data by the second storage element.

2. The method of claim 1, wherein the first storage element includes a first memory die and the second storage element includes a second memory die.

3. The method of claim 1, wherein the first storage element is associated with a first channel of a memory die, and the second storage element is associated with a second channel of the memory die.

4. The method of claim 1, wherein determining the availability includes determining that the first storage element and the second storage element are available for performing the operation on the first data.

5. The method of claim 1, wherein the first assignment state identifies processing of second data of the first stream by the first storage element.

6. The method of claim 1, wherein the second assignment state identifies the second storage element as open to receive an assignment.

7. The method of claim 1, wherein the state information is based on a number of storage elements in the set of storage elements open to receive an assignment of the first stream.

8. The method of claim 7, wherein based on the number of storage elements open to receive the assignment of the first stream falling below a threshold value, identifying a third storage element and associating the third storage element to the set of storage elements.

9. The method of claim 1, wherein based on a number of storage elements in the set of storage elements being closed to receive an assignment of the first stream, identifying a third storage element and associating the third storage element to the set of storage elements.

10. The method of claim 1, wherein the first storage element and the second storage element are configured to be managed as a single unit for performing garbage collection.

11. The method of claim 1 further comprising:
receiving a second stream;
identifying the second storage element for the second stream;
determining association of the second storage element to the first stream;
based on determining the association of the second storage element to the first stream, identifying a third storage element of the set of storage elements; and
assigning the second stream to the third storage element.

12. The method of claim 1, wherein the determining the availability of the first storage element and the second storage element is for a plurality of streams.

13. The method of claim 12, wherein at least one of the plurality of streams is for garbage collection.

14. A storage device comprising:
a set of storage elements;
a processor; and
a memory storing instructions which, when executed by the processor, cause the processor to:
receive a first stream including first data;
determine availability of a first storage element and a second storage element from the set of storage elements;
identify state information for the first stream, wherein the state information includes a first assignment state of the first stream relative to the first storage element and a second assignment state of the first stream relative to the second storage element;
based on determining the availability of the first storage element and the second storage element, and based on identifying the state information for the first stream, assign the first stream to the second storage element; and
perform an operation on the first data by the second storage element.

15. The storage device of claim 14, wherein the instructions that cause the processor to determine the availability include instructions that cause the processor to determine that the first storage element and the second storage element are available for performing the operation on the first data.

16. The storage device of claim 14, wherein the first assignment state identifies processing of second data of the first stream by the first storage element, and the second assignment state identifies the second storage element as open to receive an assignment.

17. The storage device of claim 14, wherein the state information is based on a number of storage elements in the set of storage elements open to receive an assignment of the first stream. wherein the based on the number of storage elements open to receive the assignment of the first stream falling below a threshold value, the instructions cause the processor to identify a third storage element and associate the third storage element to the set of storage elements.

18. The storage device of claim 14, wherein the based on a number of storage elements in the set of storage elements being closed to receive an assignment of the first stream, the instructions cause the processor to identify a third storage element and associate the third storage element to the set of storage elements.

19. The storage device of claim 14, wherein the first storage element and the second storage element are configured to be managed as a single unit for performing garbage collection.

20. The storage device of claim 14, wherein the instructions further cause the processor to:
receive a second stream;
identify the second storage element for the second stream;
determine association of the second storage element to the first stream; and
based on determining the association of the second storage element to the first stream, identify a third storage element of the set of storage elements; and
assign the second stream to the third storage element.
